(19) United States
(12) Patent Application Publication
(10) Pub. No.: US 2009/0214039 A1
(43) Pub. Date: Aug. 27, 2009

(54) METHOD AND SYSTEM FOR SHORT-RANGE MOBILE DEVICE COMMUNICATION MANAGEMENT

(75) Inventors: Hui Chen, New York, NY (US); Luciano Mazzella, New York, NY (US); Roxy Wu, New York, NY (US)

Correspondence Address: PERKINS COIE LLP, P.O. BOX 1208, SEATTLE, WA, 98111-1208, US

(73) Assignee: Project Omega, Inc., New York, NY (US)

(21) Appl. No.: 12/391,865

(22) Filed: Feb. 24, 2009

Related U.S. Application Data
(60) Provisional application No. 61/031,507, filed on Feb. 26, 2008.

(51) Int. Cl. H04L 9/00; H04B 7/00

(52) U.S. Cl. 380/270; 455/41.2

(57) ABSTRACT

A method and system for managing short-range mobile device communications are provided. The method includes receiving a user-defined criteria for requested information. The method includes automatically detecting a set of in-range devices, wherein each in-range device is associated with an identifier. The method includes receiving a broadcasted public information from each in-range device. The method includes, responsive to detecting the received broadcasted public information satisfies the user-defined criteria, displaying public info to a user. The method includes, responsive to a user command, transmitting a message in response to the broadcasted public information.

### CROSS REFERENCE TO RELATED APPLICATIONS

This application claims priority to provisional application No. 61/031,507 entitled “MOBILE DEVICE COMMUNICATION CONTROL SYSTEM AND METHODS” filed on Feb. 26, 2008, and which is incorporated herein by reference.

This application is related to U.S. Patent Application titled “METHOD AND SYSTEM FOR MANAGING SOCIAL NETWORKS OF A USER”, filed herewith, and which is incorporated herein by reference.

### FIELD OF THE INVENTION

The present invention relates generally to a short-range communication device and its software for managing a communication network, synchronization and data caching.

### BACKGROUND OF THE INVENTION

Mobile devices can communicate with nearby devices via wireless communications. For example, wireless communications can be established between devices with Bluetooth and other short-range radio technologies. Details about the Bluetooth protocol are available at http://www.bluetooth.com.

Humans are fallible, their memory fails, they are lazy, and they get annoyed. Often, consumer fails to note down the information that he is interested in or other important information. The spread of mobile devices such as mobile phones have provided users with additional easily accessible functionality. New technologies such as Wireless Application Protocol (WAP) and Bluetooth make mobile phones more central to user's daily existence. It is expected that the number of mobile phone users will increase significantly over the next few years.

People are eager to gather information in a timely and efficient manner. In one example, Mary and John decide to meet in a shopping mall for dinner. John plans to treat Mary to a nice dinner. John wants to make a good impression and would like to find a restaurant with Parameters of 25+ food, 25+ decor, 25+ service, cost less than $100 based on the Zagats rating system. In a prior approach, John can determine a list of available restaurants, for example, from a shopping mall information center or by accessing a shopping mall directory website. Then, John can obtain restaurant information one by one, by either walking to each restaurant or calling each restaurant. Alternatively, John can search a paper or online version of the Zagats guide for each restaurant's parameters. This process can be frustrating and time-consuming.

Furthermore, mobile device users would often like to better recall information they are exposed to throughout their days. Much information today is presented in an attractive format and provides additional details for the user to later remember or act upon. For example, an advertisement frequently includes a phone number or a website address which can provide further details on a product or service.

However, users often have memory failures, and often forget information and details, especially due to the large quantity of information available. Therefore, it often occurs that a user is unhappy for remembering seeing an important or interesting piece of information, but being unable to remember the information or the details.

Thus, there is a need to ensure an interested user is provided with information he wants for later recall.

### SUMMARY OF THE INVENTION

The systems and methods described herein allow a consumer to obtain and display information of surrounding person, business. The information is displayed on a mobile device and obtained responsive to user requests and interests. The information can be filtered by a user-defined criteria. The user can also communicate personal data, such as name, category information, and a request to other users to contact him or to provide additional information to a provided address.

Aspects of the present invention include:

A. Physical Presence Detection, allowing users to detect a presence of an object, such as a person, an item, a location, a piece of information, etc. Both acquainted and unacquainted objects can be detected, depending on how the user defines the user-defined criteria.

B. Information Exchange, allowing users to either passively exchange information when user-defined criteria are met or actively exchange information responsive to user commands.

C. Face/sub-face management. A user can have all, any or none of the available faces/sub-faces active at any given time. Each different face/sub-face can include its own user defined physical presence detection criteria. Each user-defined mobile device face corresponds to its counterpart on a Face Management System for information organization purpose. Each user-defined mobile device face corresponds to its counterpart on the Face Management System for exchanged information access purpose. For example, Faces and the Face Management System can be as discussed in U.S. Provisional Application No. 61/031,497, “METHOD AND SYSTEM FOR LINKING NODES THROUGH DIFFERENCE FACES IN SOCIAL NETWORKING” filed Feb. 26, 2008 and U.S. Patent Application titled “METHOD AND SYSTEM FOR MANAGING SOCIAL NETWORKS OF A USER”, filed herewith.

D. Function with or without a carrier network. In one embodiment, the system can function over a cellular carrier network. In another embodiment, the system can function over other wireless protocols, such as Bluetooth can be used. This allows the system to function without access to a carrier network.

Other features and advantages of the invention will be apparent from the description below with reference to the enclosed drawing, which shows schematically a communication management system according to the invention in which the method of managing a communication system according to the invention is applied.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates a hierarchy of category and security.

FIG. 2A illustrates a first example synchronization process.

FIG. 2B illustrates a second example synchronization process.

FIG. 3 illustrates a computer software system for filtering non-matching devices, storing matching information and displaying the matching information.

FIG. 4 illustrates a communication control panel navigation system.

FIG. 5 illustrates a click information caching mechanism.

FIG. 6 illustrates an example procedure for managing mobile device communications.

FIG. 7 illustrates an example mobile device configured to execute the procedure above.

FIG. 8 illustrates an example server configured to execute the procedure above.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The phrase “in one embodiment,” as used herein does not necessarily refer to the same embodiment, although it may. Similarly, the phrase “in another embodiment,” as used herein does not necessarily refer to a different embodiment, although it may.

The term “based on” is not exclusive and provides for being based on additional factors not described, unless the context clearly dictates otherwise.

Illustrative Operating Environment

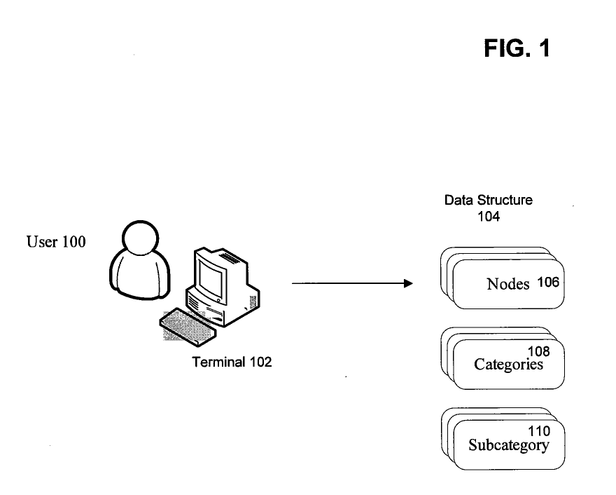

FIG. 1 illustrates a hierarchy of category and security. In an example embodiment, a user 100 can access a terminal 102 to set up and configure a data object 104. In one example, the data object 104 includes nodes 106, categories 108, and sub-categories 110.

Based on the values set in the data object 104, the user 100 determines which level of information as public information, for example, as a vcard. In one embodiment, the data object 104 is maintained on a server accessible via a web browser. In another embodiment, the data object 104 is maintained on a mobile device.

The user 100 logs in to a server via a web browser executing at a terminal 102. The user 100 can set up or redefine category and security hierarchies and determine which level of information is public information will be available. The user 100 can also set up appropriate and redefine modes that are suitable to his/her personal situations. The system can also set up the default mode for each user, the user can keep it or customize to the way that they actually want it to be.

Alternatively, the data object 104 can be stored and accessed directly on a user mobile device. Furthermore, the data object 104 can include one or more user-defined criteria, which allow the user 100 to filter incoming information received by the mobile device.

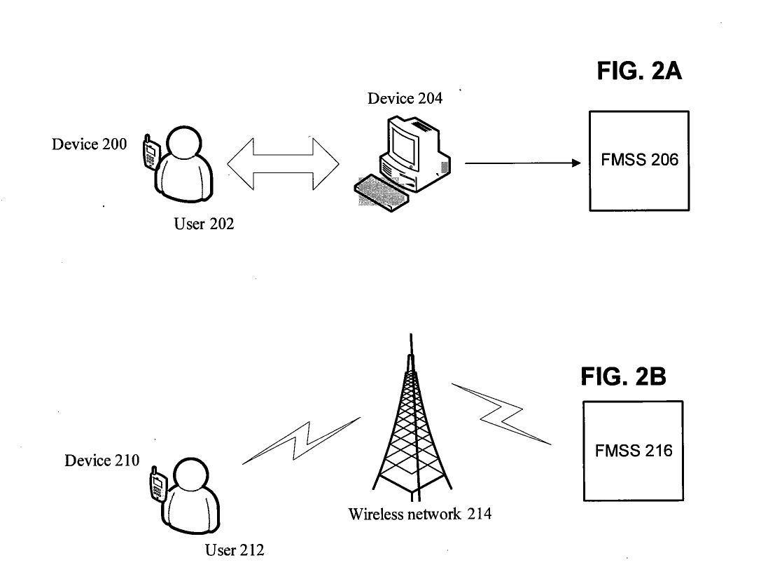

FIG. 2A illustrates a first example synchronization process. A device 200, such as a mobile device, can be accessible to a registered user 202, as discussed above. The user 202 can also physically access a computing device 204. In one example, the user 202 can log in to a predetermined web page through the computing device 204. The computing device 204 can be a workstation executing a web browser. The web page can interface between the user 202 and a Face Management System server 206. To improve performance, the computing device 204 can cache information transferred between the user 202 and the FMSS 206.

In this embodiment, the computing device 204 can wireless synchronize with the mobile device 200. The synchronization utilizing wireless communication technologies, such as Bluetooth, discussed above. The computing device 204 can communicate with the server 206 via a network such as the Internet. This allows the device 200 to be synchronized with user-defined variables and preferences stored on the FMSS 206.

In another embodiment, the user-defined variables and preferences can be stored on the computing device 204, and directly synchronized with the mobile device 200.

The functionality provided by the computing device 204 include allowing manipulation of database objects in can FMSS 206 and caching synchronization information between the mobile device 200 and the FMSS 206. In another embodiment, the above functionality can be provided by another computing device, a network, or any other means.

FIG. 2B illustrates a second example synchronization process. In this example, a mobile device 210 directly synchronizes with a FMSS 216 over a wireless network 214, such as a cellular network.

In this example, the mobile device 210 can be a cell phone or a wireless personal digital assistant (PDA) and directly accesses the wireless network 214. For example, the wireless network 214 can be a cellular network or other wireless network configured to carry data and other information. This allows a user 212 to directly synchronize the device 210 with the FMSS 216, removing the need for a computing device to serve as an intermediary.

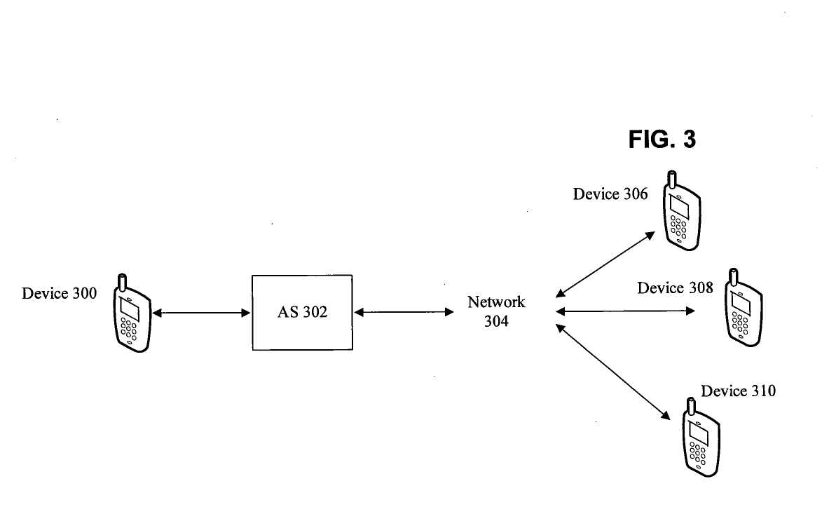

FIG. 3 illustrates a computer software system for filtering non-matching devices, storing matching information and displaying the matching information. A mobile device 300 may detect all communication devices within communication range such as device 306, 308, and 310. For example, the mobile device 300 can utilize a short-range wireless technology, such as Bluetooth, to scan for nearby devices. Each device 306, 308, and 310

It will be appreciated that while only three devices 306, 308, and 310 are depicted, any number of devices can exist within the system. It will also be appreciated that any number of such devices can be within wireless communication range of the mobile device 300 at any given time.

In one embodiment, devices 306, 308, and 310 continuously broadcast public information. For example, the public information and a dummy key can be packed as a file token, which can be any format supported by the devices, such as Extended Markup Language (XML). An application system AS 302 includes logic and filters out all information that does not meet the user-defined criteria, discussed above.

The AS 302 further stores the relevant information in its own light weight database system. The mobile device 300 can then query the AS 302 responsive to user commands and display the information through the navigation panel or other interface on the mobile device.

It will be appreciated that it is beneficial to standardize a format of the user-defined criteria to improve comparison performance. One approach is to categorize information in a similar fashion as the International Telecommunication Union's (ITU) Telephone Numbering Plan. The scheme can be modified by replacing the Country Codes with Category Codes (such as restaurant, shopping). The scheme can be further modified by replacing the Area Codes with Sub-Category Codes (such as fast food restaurant, clothes shopping). It will be appreciated that any number of sub-categories can be implemented.

It will be appreciated that other standardized formats of user-defined criteria can be used.

In one example embodiment, the AS 302 can be implemented on the mobile device 300. The mobile device 300 detects and communications with the devices 306, 308, and 310 over a network 304. The network 304 can be Bluetooth or any other short-range wireless communications network.

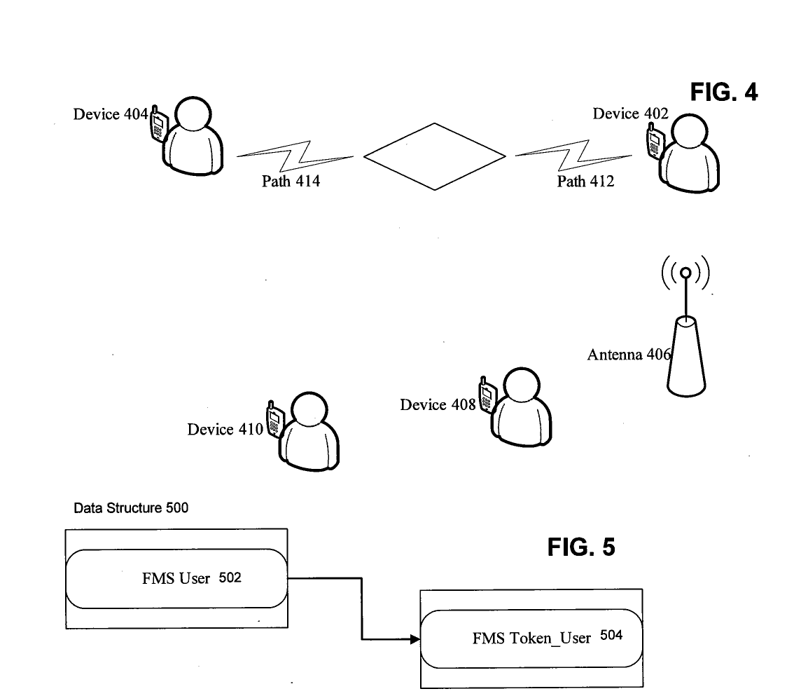

FIG. 4 illustrates a communication control panel navigation system. In one embodiment, a mobile device 402 can communicate with a variety of devices over a variety of networks. The mobile device 402 provides a communication control navigation interface to a user, who can manage the communications. For example, the interface can allow the user to navigate other devices and select devices that the user wishes to communicate with.

The mobile device 402 can wirelessly communicate with a device 404 over a path 412 and 414. The device 402 can also communicate with an antenna 406 and devices 410 and 408. For example, the antenna 406 can be a repeater, which increases the effective range of the mobile device 402. In one example embodiment, the devices can be within a geographically limited area, such as within a shopping mall. In one example embodiment, the devices can include stationary kiosks configured to communicate via a predefined wireless protocol.

A control panel at the mobile device 402 displays detected devices within wireless communication range. Each detected device can be accompanied by a short description of information available from the device. As discussed above, each device can continuously broadcast public information. The user can select devices broadcasting information of interested.

In one embodiment, the public information can be an invitation to make an offer. The user can respond with an offer, and the receiving party can decide to accept or not. In one embodiment, the offer will remain open for a reasonable time. This time period can be predetermined by the user, or by a system default, such as two weeks. The receiving party can decide to accept immediately or at a later time with more information. The accepting party can also choose to set up a signal to alert the sending party of his acceptance.

Upon coming into range, the mobile device 402 can exchange identification information (such as an identifier token) according to a predefined wireless communication standard (such as Bluetooth). In one embodiment, a user can be required to first agree before any information is exchanged. After receiving the identification information, the user can input a command indicating a desire to request additional information relating to the public information. For example, the initial public information can be an advertisement. If the user is interested, the user can request additional information.

Data received by the mobile device 402, such as public information from other devices can be presented in different categories. For example, advertisements can be marked with a relevant category such as “dining”, “drinks”, or “entertainment.”

In one embodiment, the additional data received has a standardized format, such as XML or HyperText Markup Language (HTML), so that it can be easily viewed with a standard web browser. Such data can also be read with a WAP capable phone (such as the Apple iPhone). Furthermore, the mobile device 402 can establish a direct connection with a transmitting device responsive to data requirements and user requests. For example, the user of mobile device 402 can request a cellular phone number or other contact information. The user of communication device 402 may further request a cellular phone number of the other party.

Having such possibilities of communication the user of the communication device 402 has many ways to leave his personal data for personal contact later and to fetch small or large amounts of data relating to the certain mode that the user predefined from the communication device 404 directly to communication device 402. If both devices are WAP capable devices, it is possible for both devices to establish a communication path directly with a server. In this example, data retrieved from the communication device 404 should contain the unique key in FMS system and additional trailer information such as specific face, level of security, and an URL relating to the user profile information of the communication device 404. All of this information can be retrieved by communication device 402 automatically.

It may well happen that communication device 402 detects within range with several communication devices at the same time, such as communication devices 404, 408 and 410 as shown. In this case, the user of communication device 402 can predefine the scenario to sort all these public personal information from those nearby communication devices in a specific order. This will enable the user of the communication device 402 to quickly scan the basic information for the one/ones he is/are most interested in. One ordering type may be by category of category information, to which extent the personal information must comprise category identification.

FIG. 5 illustrates a click information caching mechanism. A data structure 500 can store both incoming and outgoing information from a mobile device. The data structure can link a user 502 with a token user 504.

A user can select a device to be queried by clicking on a device representation in a user interface. Outgoing information can be stored, such as target information and its own mode and targeting information. The target information is a dummy look up key in Face Management System. The target information can be updated when the receiving party accepts an outstanding offer. The target dummy key can link to an actual user identification information in Face Management System. The user can also choose to store basic public information that he/she is authenticated to receive.

The abovementioned information can be stored in light weight database system utilizing different approaches. Some example approaches include:

1. Implement a proprietary data caching mechanism, such as creating multi-dimensioned arrays or other data structures to store the above information.

2. Implement a commercial or open source light weight database system, such as Access Point.

3. Implement a computer software program utilizing dedicated memory space provided by wireless service providers.

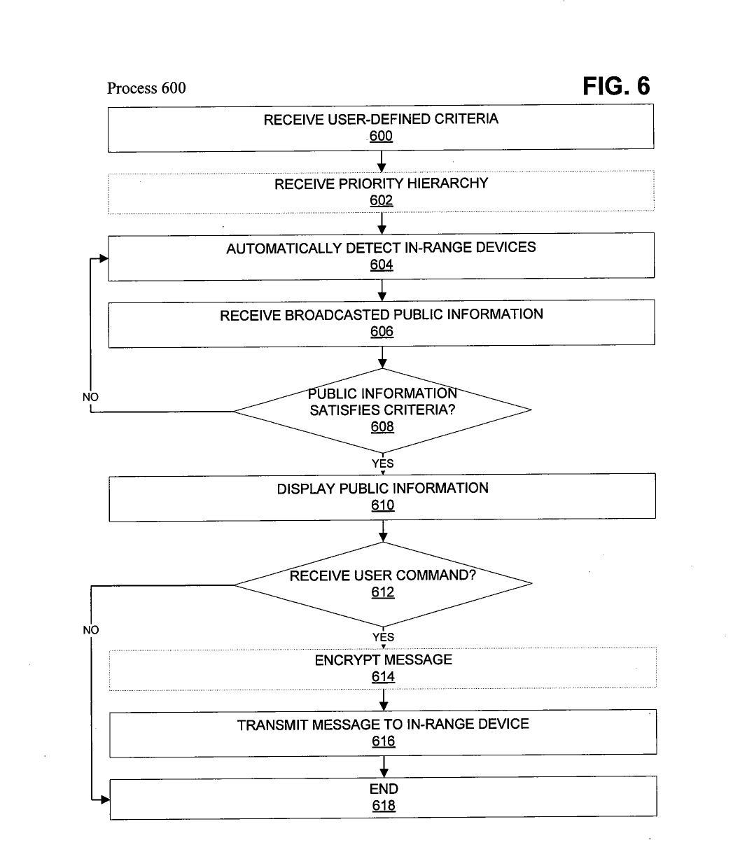

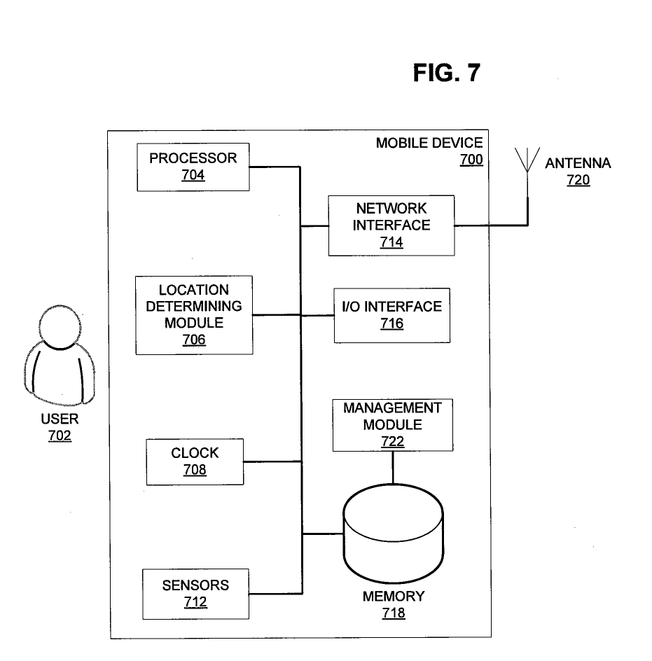

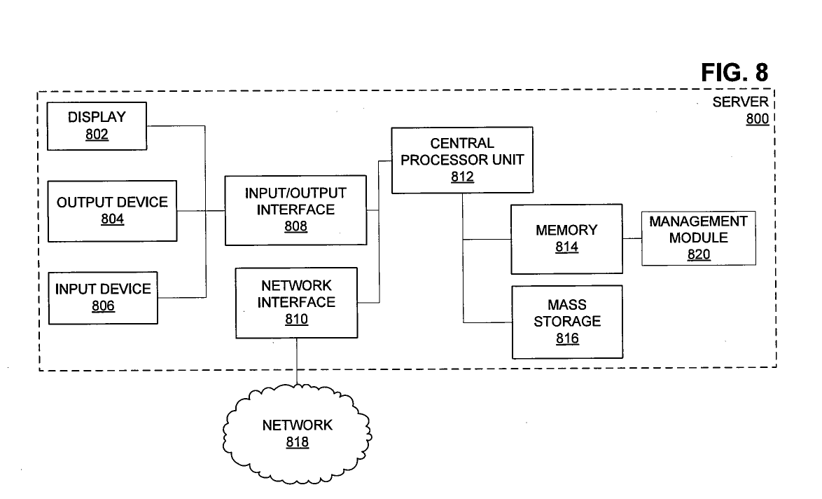

FIG. 6 illustrates an example procedure for managing mobile device communications. For example, the procedure can provide functionality described above. For example, the procedure can execute on a mobile device as illustrated in FIG. 7, a server as illustrated in FIG. 8, or a combination thereof.

In 600, the mobile device receives a user-defined criteria specifying a type or area of information a user is interested in. The user-defined criteria can define, for example, specific categories or areas of information to be displayed. The user-defined criteria can also specify specific senders or category of senders from whom information will be displayed or blocked. Any filtering criteria can be used as a user-defined criteria.

In one example embodiment, the user can enter the user-defined criteria at the mobile device. In another example embodiment, the user can enter the user-defined criteria at a workstation, which synchronizes with the mobile device, for example, via a wired or short-ranged wireless connection. In another example embodiment, the user can interface with a server via an Internet-based user interface. The user enters the user-defined criteria at the server, which synchronizes with the mobile device, for example, over a cellular data network.

In 602, the mobile device optionally receives a priority hierarchy. The priority hierarchy can define an order in which the mobile device detects and processes in-range devices. For example, the user can specify that fixed kiosks are detected first, followed by other mobile device. In this example, each device can periodically broadcast an identifier, wherein the identifier identifies the type of device. In another example, the user can specify specific devices to be detected first.

Similar to the user-defined criteria discussed above, the priority hierarchy can be received from a plurality of sources.

In 604, the mobile device can automatically detect in-range devices. As discussed above, the mobile device can attempt to detect in-range devices in accordance with a specified short-range wireless network protocol. In one example, the mobile device search for nearby devices with existing Bluetooth search protocols.

In another embodiment, the mobile device can utilize its local position, as determined by any of various position-detecting technologies, discussed below. In this embodiment, the mobile device can transmit its location to a server, which a set of nearby devices within a predetermined distance. The server can then transmit public information associated with each in-range device to the mobile device.

In 606, the mobile device can receive and parse broadcasted public information from each in-range device. Each in-range device can periodically broadcast public information along with its identifier, as discussed above. The public information can include any information, such as an advertisement, a request for information, an information message, etc. The public information can be optimized for delivery over the short-range wireless network, for example, by limiting a size and content of the message.

In 608, the mobile device tests whether the public information received in 606 satisfies the user-defined criteria. As discussed above, the user-defined criteria can define information of interest to the user. For example, the user-defined criteria can specify that only restaurant information related to three-star rated or higher restaurants are of interest.

It will be appreciated that each pubic broadcast received will be processed by 608.

If the public information satisfies the user-defined criteria, the mobile device proceeds to 610. If the public information does not satisfy the user-defined criteria, the mobile device returns to 604 and continues by detecting in-range devices.

In 610, the mobile device displays relevant public information to the user. For example, the mobile device can display a received n advertisement or coupon offer from a three-star rated restaurant to the user. In this example, the public information can be broadcasted from a shopping mall information kiosk or from the restaurant itself as the user walked by. In another example, public information can be broadcasted from other mobile devices, wherein the user of each mobile device broadcasts the advertisement in exchange for consideration from the advertiser.

In 612, the mobile device tests whether a user command has been received. The user can view a list of public information satisfying the user-defined criteria received from in-range devices. For example, the user can enter a user command via a mobile device user interface. The user can select an advertisement to view, elect to transmit a request for more information, elect to transmit an offer, or any other interaction with the transmitting in-range device.

In 614, the mobile device can optionally encrypt an outgoing message. The outgoing message can be a response to the public information, as discussed above. The outgoing message can include an identifier of the mobile device and other personal information, which can be secured for user privacy.

Alternatively, other means of securing the outgoing message, such as using a hash code, can be used.

In 616, the mobile device can transmit the outgoing message to the transmitting in-range device. The outgoing message can be encrypted or otherwise secured, as discussed above.

In 618, the mobile device can exit the procedure.

FIG. 7 illustrates an example mobile device configured to execute the procedure above. The mobile device 700 can be a cellular phone, a PDA, or a similar portable device used by a user 702. The mobile device 700 is configured to allow a user to interact with a social network profile by executing a management application 722.

The mobile device 700 can include a processor 704. The processor 704 can be a general purpose processor configured to execute computer-readable instructions operating the mobile device 700 and associated peripherals. It will be appreciated that any number of processors can be included in the mobile device 700, including specialized processors. The processor 704 can also be configured to execute the management module 722, as discussed below..

The mobile device 700 can include a location determining module 706. The module 706 can be a GPS receiver module configured to receive GPS signals and calculate a physical location of the mobile device 700 based on the received GPS signals and an internal clock time. The physical location calculation can be optimized by, for example, averaging the GPS signals over time or incorporating a signal from a known nearby location. Alternatively, the module 706 can calculate a physical location by cellular signal triangulation or via short-range wireless network detection.

The mobile device 700 can include a clock 708. The clock 708 can provide a local time. The clock 708 can also provide an internal time for use with the GPS module. The clock 708 can be periodically updated from a server in communications with the mobile device 700.

The mobile device 700 includes additional sensors 712. Additional sensors can include audio input devices or optical input devices. Audio input devices can include microphones. Optical input devices can include cameras or light sensors. The sensors 712 can be configured to detect appropriate input and convert the input into input signals transmitted to the processor 702.

The mobile device 700 can include a network interface 714. For example, the network interface 714 can communicate with a wireless network such as WiMax, cellular wireless network such as CDMA, GSM, a wired network such as Ethernet, or a short range wireless network such as Bluetooth, Wi-Fi, or Zigbee. The mobile device 700 can include multiple network interfaces or a network interface configured to interface with multiple networks. Wireless network interfaces can communicate via an antenna 970.

An Ethernet network allows the mobile device 700 to communicate when plugged in. The mobile device 700 can be assigned an IP address on the wired network. A short-range wireless network can be a Wi-Fi, Wi-Bree or Bluetooth network.

The mobile device 700 can include an input/output interface 716. The interface 716 can receive user inputs from an input device and convert the user inputs into user commands. For example, input devices can include a touch screen display, a keypad, a microphone, an optical device, a pointer device, a scroll wheel, or other input devices.

The interface 716 can also transmit output to an output device in a form accessible to the user 702. For example, output devices can include a touch screen, a display screen, a speaker, an audio-out jack, an electromechanical motor for providing tactile output, or other output devices.

The mobile device 700 can include a memory 718. The memory 718 can be read-only or read-write, persistent or volatile storage memory accessible to the processor 704. The memory 718 can store data required by the mobile device 700 for operation and applications for execution.

The mobile device 700 can include an antenna 720. The antenna 720 can be configured to transmit and receive wireless signals from a wireless network.

The mobile device 700 can store and execute a management application 722. The management module 722 can be computer-readable executable code configured to manage communications with nearby in-range devices and a server, as discussed above.

FIG. 8 illustrates an example server configured to execute the procedure above. A server 800 is configured to communicate with a mobile device, as illustrated in FIG. 7.

The server 800 includes a display 802. The display 802 can be equipment that displays viewable images, graphics, and text generated by the server 800 to a server administrator. For example, the display 802 can be a cathode ray tube or a flat panel display such as a TFT LCD. The display 802 includes a display surface, circuitry to generate a viewable picture from electronic signals sent by the server 800, and an enclosure or case. The display 802 can interface with an input/output interface 808, which converts data from a central processor unit 812 to a format compatible with the display 802.

The server 800 includes one or more output devices 804. The output device 804 can be any hardware used to communicate outputs to the administrator. For example, the output device 804 can be audio speakers and printers or other devices for providing output.

The server 800 includes one or more input devices 806. The input device 806 can be any hardware used to receive inputs from the administrator. The input device 806 can include keyboards, mouse pointer devices, microphones, scanners, video and digital cameras, etc.

The server 800 includes an input/output interface 808. The input/output interface 808 can include logic and physical ports used to connect and control peripheral devices, such as output devices 804 and input devices 806. For example, the input/output interface 808 can allow input and output devices 804 and 806 to communicate with the server 800.

The server 800 includes a network interface 810. The network interface 810 includes logic and physical ports used to connect to one or more networks. For example, the network interface 810 can accept a physical network connection and interface between the network and the workstation by translating communications between the two. Example networks can include Ethernet, the Internet, or other physical network infrastructure. Alternatively, the network interface 810 can be configured to interface with a wireless network. Alternatively, the server 800 can include multiple network interfaces for interfacing with multiple networks.

As illustrated, the network interface 810 communicates over a network 818. Alternatively, the network interface 810 can communicate over a wired network. It will be appreciated that the server 800 can communicate over any combination of wired, wireless, or other networks.

The server 800 includes a central processing unit (CPU) 812. The CPU 812 can be an integrated circuit configured for mass-production and suited for a variety of computing applications. The CPU 812 can sit on a motherboard within the server 800 and control other workstation components. The CPU 812 can communicate with the other workstation components via a bus, a physical interchange, or other communication channel.

The server 800 includes memory 814. The memory 814 can include volatile and non-volatile storage memory accessible to the CPU 812. The memory can be random access and provide fast access for graphics-related or other calculations. In an alternative embodiment, the CPU 812 can include on-board cache memory for faster performance.

The server 800 includes mass storage 816. The mass storage 816 can be volatile or non-volatile storage configured to store large amounts of data. The mass storage 816 can be accessible to the CPU 812 via a bus, a physical interchange, or other communication channel. For example, the mass storage 816 can be a hard drive, a RAID array, flash memory, CD-ROMs, DVDs, HD-DVD or Blu-Ray mediums.

The server 800 communicates with a network 818 via the network interface 810. The server 800 can communicate with a mobile device over the network 818.

The server 800 can execute a management module 820 stored in memory 814. The management module 820 can interface with a mobile device as illustrated in FIG. 7 and provide functionality discussed above.

It will be appreciated that the public information discussed above can be stored on individual devices for broadcasted. In another embodiment, the public information can be stored on the server 800 or in memory accessible to the server 800. In this embodiment, the server 800 transmits the public information to selected mobile devices, as discussed above.

As discussed above, an example embodiment of the present invention can be a method for managing short-range mobile device communications. The method includes receiving a user-defined criteria for requested information. The method includes automatically detecting a set of in-range devices, wherein each in-range device is associated with an identifier. The method includes receiving a broadcasted public information from a transmitting in-range device selected from the set of in-range devices. The method includes, responsive to detecting the received broadcasted public information satisfies the user-defined criteria, displaying public info to a user. The method includes, responsive to a user command, transmitting a message in response to the broadcasted public information. The message can be transmitted to the transmitting in-range device and is at least one of: accepting an offer of the broadcasted public information, requesting additional information from the in-range device, purchase a good or service offered in the broadcasted public information, and submitting personal information to the in-range device. The broadcasted public information can be at least one of: an advertisement, a public message, and a request for user information. The advertisement can be available for a limited time. The set of in-range devices can be detected via a short-range wireless protocol, selected from at least one of: Bluetooth, Wi-Fi, and Zigbee. The set of in-range devices can be detected via a long-range wireless protocol selected from at least one of: CDM, GSM, and WiMax. The method includes receiving a user-specified priority hierarchy defining an order in which to detect the set of in-range devices. The method includes encrypting the message, wherein the encrypted message is transmitted to a server.

Another example embodiment of the present invention can be a mobile device for managing short-range mobile device communications. The mobile device can include a processor. The processor can be configured to receive a user-defined criteria for requested information. The processor can be configured to automatically detecting a set of in-range devices, wherein each in-range device is associated with an identifier. The processor can be configured to receive a broadcasted public information from a transmitting in-range device selected from the set of in-range devices. The processor can be configured to responsive to detecting the received broadcasted public information satisfies the user-defined criteria, display public info to a user. The processor can be configured to, responsive to a user command, transmit a message in response to the broadcasted public information. The message can be transmitted to the transmitting in-range device and is at least one of: accepting an offer of the broadcasted public information, requesting additional information from the in-range device, purchase a good or service offered in the broadcasted public information, and submitting personal information to the in-range device. The broadcasted public information can be at least one of: an advertisement, a public message, and a request for user information. The advertisement can be available for a limited time. The set of in-range devices can be detected via a short-range wireless protocol, selected from at least one of: Bluetooth, Wi-Fi, and Zigbee. The set of in-range devices can be detected via a long-range wireless protocol selected from at least one of: CDM, GSM, and WiMax. The mobile device can include a memory in communications with the processor, the memory configured to store a user-specified priority hierarchy defining an order in which to detect the set of in-range devices. The mobile device can include an encryption module, the encryption configured to encrypt the message, wherein the encrypted message is transmitted to a server.

Another example embodiment of the present invention can be a computer-readable storage medium including instructions adapted to execute a method for managing short-range mobile device communications. The method includes receiving a user-defined criteria for requested information. The method includes automatically detecting a set of in-range devices, wherein each in-range device is associated with an identifier. The method includes receiving a broadcasted public information from a transmitting in-range device selected from the set of in-range devices. The method includes, responsive to detecting the received broadcasted public information satisfies the user-defined criteria, displaying public info to a user. The method includes, responsive to a user command, transmitting a message in response to the broadcasted public information. The message can be transmitted to the transmitting in-range device and is at least one of: accepting an offer of the broadcasted public information, requesting additional information from the in-range device, purchase a good or service offered in the broadcasted public information, and submitting personal information to the in-range device. The broadcasted public information can be at least one of: an advertisement, a public message, and a request for user information. The advertisement can be available for a limited time. The set of in-range devices can be detected via a short-range wireless protocol, selected from at least one of: Bluetooth, Wi-Fi, and Zigbee. The set of in-range devices can be detected via a long-range wireless protocol selected from at least one of: CDM, GSM, and WiMax. The method includes receiving a user-specified priority hierarchy defining an order in which to detect the set of in-range devices. The method includes encrypting the message, wherein the encrypted message is transmitted to a server.

The above specification, examples, and data provide a complete description of the manufacture and use of the composition of the invention. For instances, the communication device 1 in Diagram 4 not only can be a real person but also be any commercial companies such as a restaurant, book store and etc.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for managing short-range mobile device communications, comprising:
receiving a user-defined criteria for requested information;
automatically detecting a set of in-range devices, wherein each in-range device is associated with an identifier;
receiving a broadcasted public information from a transmitting in-range device selected from the set of in-range devices;
responsive to detecting the received broadcasted public information satisfies the user-defined criteria, displaying public info to a user; and
responsive to a user command, transmitting a message in response to the broadcasted public information.

2. The method of claim 1, wherein the message is transmitted to the transmitting in-range device and is at least one of: accepting an offer of the broadcasted public information, requesting additional information from the in-range device, purchase a good or service offered in the broadcasted public information, and submitting personal information to the in-range device.

3. The method of claim 1, wherein the broadcasted public information is at least one of: an advertisement, a public message, and a request for user information.

4. The method of claim 3, wherein the advertisement is available for a limited time.

5. The method of claim 1, wherein the set of in-range devices is detected via a short-range wireless protocol, selected from at least one of: Bluetooth, Wi-Fi, and Zigbee.

6. The method of claim 1, wherein the set of in-range devices is detected via a long-range wireless protocol selected from at least one of: CDMA, GSM, and WiMax.

7. The method of claim 1, further comprising:
receiving a user-specified priority hierarchy defining an order in which to detect the set of in-range devices.

8. The method of claim 1, further comprising:
encrypting the message, wherein the encrypted message is transmitted to a server.

9. A mobile device for managing short-range mobile device communications, comprising:
a processor, the processor configured to,
receive a user-defined criteria for requested information;
automatically detecting a set of in-range devices, wherein each in-range device is associated with an identifier,
receive a broadcasted public information from a transmitting in-range device selected from the set of in-range devices,
responsive to detecting the received broadcasted public information satisfies the user-defined criteria, display public info to a user; and
responsive to a user command, transmit a message in response to the broadcasted public information.

10. The mobile device of claim 9, wherein the message is transmitted to the transmitting in-range device and is at least one of: accepting an offer of the broadcasted public information, requesting additional information from the in-range device, purchase a good or service offered in the broadcasted public information, and submitting personal information to the in-range device.

11. The mobile device of claim 9, wherein the broadcasted public information is at least one of: an advertisement, a public message, and a request for user information.

12. The mobile device of claim 11, wherein the advertisement is available for a limited time.

13. The mobile device of claim 9, wherein the set of in-range devices is detected via a short-range wireless protocol, selected from at least one of: Bluetooth, Wi-Fi, and Zigbee.

14. The mobile device of claim 9, wherein the set of in-range devices is detected via a long-range wireless protocol selected from at least one of: CDM, GSM, and WiMax.

15. The mobile device of claim 9, further comprising:
a memory in communications with the processor, the memory configured to store a user-specified priority hierarchy defining an order in which to detect the set of in-range devices.

16. The mobile device of claim 9, further comprising:
an encryption module, the encryption configured to encrypt the message, wherein the encrypted message is transmitted to a server.

17. A computer-readable storage medium including instructions adapted to execute a method for managing short-range mobile device communications, the method comprising:
receiving a user-defined criteria for requested information;
automatically detecting a set of in-range devices, wherein each in-range device is associated with an identifier;
receiving a broadcasted public information from a transmitting in-range device selected from the set of in-range devices;
responsive to detecting the received broadcasted public information satisfies the user-defined criteria, displaying public info to a user; and
responsive to a user command, transmitting a message in response to the broadcasted public information.

18. The medium of claim 17, wherein the message is transmitted to the transmitting in-range device and is at least one of: accepting an offer of the broadcasted public information, requesting additional information from the in-range device, purchase a good or service offered in the broadcasted public information, and submitting personal information to the in-range device.

19. The medium of claim 17, wherein the broadcasted public information is at least one of: an advertisement, a public message, and a request for user information.

20. The medium of claim 19, wherein the advertisement is available for a limited time.

21. The medium of claim 17, wherein the set of in-range devices is detected via a short-range wireless protocol, selected from at least one of: Bluetooth, Wi-Fi, and Zigbee.

22. The medium of claim 17, wherein the set of in-range devices is detected via a long-range wireless protocol selected from at least one of: CDM, GSM, and WiMax.

23. The medium of claim 17, the method further comprising:
receiving a user-specified priority hierarchy defining an order in which to detect the set of in-range devices.

24. The medium of claim 17, the method further comprising:
encrypting the message, wherein the encrypted message is transmitted to a server.
